(19) United States
(12) Patent Application Publication
(10) Pub. No.: US 2019/0211589 A1
(43) Pub. Date: Jul. 11, 2019

(54) DOUBLE PULL HOOD LATCH ASSEMBLY

(71) Applicant: MAGNA CLOSURES INC., Newmarket (CA)

(72) Inventors: Fres XU, Kunshan (CN); Chris HUANG, Kunshan (CN)

(21) Appl. No.: 16/239,658

(22) Filed: Jan. 4, 2019

Related U.S. Application Data
(60) Provisional application No. 62/614,076, filed on Jan. 5, 2018.

(51) Int. Cl. E05B 83/24; E05B 85/26

(52) U.S. Cl. CPC E05B 83/24; B62D 25/12; E05B 85/26

(57) ABSTRACT

A latch for a vehicle closure panel includes a housing, ratchet, pawl, release lever, and double pull lever. The ratchet is mounted for pivoting movement between primary and secondary closed positions and an open position. The pawl is mounted for pivoting movement between primary and secondary locking positions and an unlocking position. The release lever is mounted for pivoting movement between home and actuated positions. The double pull lever is attached to a release cable and mounted for pivoting movement between inoperative and operative positions. Movement of the release lever to the actuated position in response to a force applied on the double pull lever by the release cable, while in the inoperative position, drives the pawl from the primary locking position to the secondary locking position. Movement of the release lever to the actuated position in response to a force applied on the double pull lever by the release cable, while in the operative position, drives the pawl from the secondary locking position to the unlocking position.

### CROSS-REFERENCE TO RELATED APPLICATION

This application claims the benefit of U.S. Provisional Application Ser. No. 62/614,076, filed Jan. 5, 2018, which is incorporated herein by reference in its entirety.

### FIELD

The present disclosure relates to latches for closure panels and more particularly to vehicle hood latches.

### BACKGROUND

Latches for vehicle hoods and the like are typically actuated in two stages. During a first stage a handle is actuated inside the vehicle which moves the latch from a primary closed position to secondary closed position. To release the latch completely the vehicle occupant typically must exit the vehicle and manually actuate a latch lever that is under the hood. This may be inconvenient in some situations.

In view of the above, there remains a need to develop latches for vehicle hoods which address and overcome limitations associated with known latches.

### SUMMARY

This section provides a general summary of the present disclosure and is not intended to be a comprehensive disclosure of its full scope or all of its features, aspects and objectives.

In accordance with one aspect of the disclosure, a latch for a vehicle closure panel is provided. The latch includes a ratchet movable between a primary closed position, a secondary closed position and an open position. The ratchet is biased toward the open position. The latch further includes a pawl movable between a primary locking position whereat a pawl locking surface of the pawl engages a primary locking surface of the ratchet to hold the ratchet in the primary closed position, a secondary locking position whereat the pawl locking surface engages a secondary locking surface of the ratchet to hold the ratchet in the secondary closed position, and an unlocking position, wherein the pawl is biased toward the primary locking position. The latch further yet includes a release lever and a double pull lever mounted to the release lever, wherein the release lever is movable between a home position and an actuated position. The double pull lever is configured for attachment to a release cable. The double pull lever is moveable between an inoperative position and an operative position. When the double pull lever is in the inoperative position, movement of the release lever to the actuated position, in response to a force applied to the double pull lever by a first actuation of the release cable, causes the release lever to engage the pawl and drive the pawl from the primary locking position to the secondary locking position. When the double pull lever is in the operative position, movement of the release lever to the actuated position, in response to a force applied to the double pull lever by a second actuation of the release cable, causes the double pull lever to engage the pawl and drive the pawl from the secondary locking position to the unlocking position.

In accordance with a further aspect of the disclosure, when the pawl is driven from the primary locking position to the secondary locking position by the release lever, the double pull lever is prevented from moving to the operative position, and when the pawl is in the secondary locking position, movement of the double pull lever to the operative position is permitted in response to a force applied to the double pull lever by the release cable.

In accordance with a further aspect of the disclosure, the pawl obstructs the double pull lever from moving to the operative position when the pawl is between the primary locking position and the secondary locking position, thereby allowing and causing movement of the pawl from the primary locking position to the secondary locking position as a result of forceful engagement of the release lever with the pawl under actuated forcible driving action exerted on the double pull lever via actuation of the release cable.

In accordance with a further aspect of the disclosure, the pawl inhibits relative rotation between the double pull lever and the release lever when the pawl is moving from the primary locking position toward the secondary locking position, thereby causing the double pull lever to be maintained in the inoperative position during movement of the pawl from the primary locking position to the secondary locking position, thereby preventing inadvertent movement of the ratchet to the open position when the pawl is moved toward the secondary locking position.

In accordance with a further aspect of the disclosure, the double pull lever is unobstructed from rotating relative to the release lever when the pawl is in the secondary locking position, and thus, the double pull lever can rotate from the inoperative position to the operative position when the pawl is in the secondary locking position and a force is applied to the double pull lever by the release cable.

In accordance with a further aspect of the disclosure, the double pull lever can be configured to rotate into abutment with a positive stop on the release lever to prevent the double pull lever from over-traveling the operative position when the pawl is being biased to move under direct contact with the double pull lever from the secondary locking position toward the unlocking position.

In accordance with a further aspect of the disclosure, the release lever is configured to directly abut the pawl to drive the pawl from the primary locking position to the secondary locking position, and the double pull lever is configured to directly abut the pawl to drive the pawl from the secondary locking position to the unlocking position.

In accordance with a further aspect of the disclosure, the double pull lever can be biased toward the inoperative position by a second bias member, with the first bias member acting on the release lever imparting a first bias force and the second bias member acting on the double pull lever imparting a second bias force, with the first bias force being greater than the second bias force.

In accordance with a further aspect of the disclosure, when the pawl is in the primary locking position, the release lever has a selected amount of reach (range of driving movement) that allows the pawl to be driven from the primary locking position to the secondary locking position during movement of the release lever from the home position to the actuated position under the urging of the double pull lever caused by a force acting on the double pull lever by the release cable, and when the pawl is in the secondary locking position, the double pull lever is movable to a position to extend the effective reach of the release lever, via the double pull lever, to drive the pawl from the secondary locking position to the unlocking position during a pulling force being applied to the double pull lever by the release cable.

In accordance with one aspect of the disclosure, a latch is provided including a housing and a ratchet mounted to the housing, with the ratchet being movable between a primary closed position, a secondary closed position and an open position, wherein the ratchet is biased toward said open position. A pawl is mounted to the housing, with the pawl being movable between a primary locking position whereat a pawl locking surface of the pawl engages a primary locking surface of the ratchet to hold the ratchet in the primary closed position, a secondary locking position whereat the pawl locking surface engages a secondary locking surface of the ratchet to hold the ratchet in the secondary closed position, and an unlocking position, wherein the pawl is biased toward the primary locking position. A release lever is mounted to the housing, with the release lever being movable between a home position and an actuated position, wherein the release lever is biased toward the home position by a first bias member. Further yet, a double pull lever is configured for direct attachment to a release cable assembly, with the double pull lever being mounted to the release lever for movement between an inoperative position and an operative position. When the double pull lever is in the inoperative position, movement of the release lever to the actuated position, in response to a force applied to the double pull lever by a first actuation of the release cable assembly, causes the release lever to engage the pawl and drive the pawl from the primary locking position to the secondary locking position. When the double pull lever is in the operative position while the pawl is in the secondary locking position, movement of the release lever to the actuated position, in response to a force applied to the double pull lever by a second actuation of the release cable assembly, causes the double pull lever to drive the pawl from the secondary locking position to the unlocking position.

In accordance with one aspect of the disclosure, a latch is provided including a ratchet movable between a primary closed position, a secondary closed position and an open position, with the ratchet being biased toward the open position. The latch further includes a pawl movable between a primary locking position whereat a pawl locking surface of the pawl engages a primary locking surface of the ratchet to hold the ratchet in the primary closed position, a secondary locking position whereat the pawl locking surface engages a secondary locking surface of the ratchet to hold the ratchet in the secondary closed position, and an unlocking position, wherein the pawl is biased toward the primary locking position. The latch further includes a release lever movable between a home position and an actuated position and a double pull lever configured for direct attachment to a release cable. The double pull lever is mounted to the release lever for pivotal movement between an inoperative position and an operative position. When the double pull lever is in the inoperative position, movement of the release lever to the actuated position, in response to a first actuation of the release cable, causes the release lever to directly engage the pawl and drive the pawl from the primary locking position to the secondary locking position. When the double pull lever is in the operative position, movement of the release lever to the actuated position, in response to a second actuation of the release cable, causes the double pull lever to directly engage the pawl and drive the pawl from the secondary locking position to the unlocking position.

Further areas of applicability will become apparent from the detailed description provided herein. As noted, the description provided in this summary section are intended for purposes of illustration only and is not intended to limit the scope of the present disclosure.

### BRIEF DESCRIPTION OF THE DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the written description when considered in combination with the appended Figures, wherein:

FIG. 1 illustrates an example motor vehicle equipped with a double pull hood latch assembly in accordance with one aspect of the disclosure;

FIG. 2 is a side view of a double pull hood latch assembly of the motor vehicle of FIG. 1 having a ratchet shown in phantom maintaining a striker in a secondary closed position and in solid maintaining the striker in a primary closed position;

FIG. 3 is a plan view of the double pull hood latch assembly of FIG. 2 shown in the primary closed position;

FIG. 4 is a plan view of the double pull hood latch assembly of FIG. 2 showing initiation of a first actuating pull of a release cable with the ratchet shown being moved away from the primary closed position;

FIG. 5 is a view similar to FIG. 4 showing a continuation of the first actuating pull of the release cable with the ratchet shown in the secondary closed position and the release cable and a release lever in a fully actuated position;

FIG. 6 is view similar to FIG. 5 with the release cable and the release lever in a fully returned, home position;

FIG. 7 is a plan view of the double pull hood latch assembly of FIG. 2 showing initiation of a second actuating pull of the release cable with the ratchet shown in the secondary closed position;

FIG. 8 is a view similar to FIG. 7 showing a continuation of the second actuating pull of the release cable with the ratchet shown in the secondary closed position;

FIG. 9 is a view similar to FIG. 8 showing a continuation of the second actuating pull of the release cable with the ratchet shown being moved away from the secondary closed position;

FIG. 10 is a view similar to FIG. 9 showing a continuation of the second actuating pull of the release cable with the ratchet shown moved to the open position and the release cable and a release lever in the fully actuated position;

FIG. 11 is a view similar to FIG. 10 with the release cable and the release lever in the fully returned, home position;

FIG. 12 is a plan view of the double pull hood latch assembly of FIG. 2 showing a striker of a vehicle closure panel being moved toward the ratchet along the direction of arrow A;

FIG. 13 is a view similar to FIG. 12 showing the striker continuing along the direction of arrow A and the ratchet being moved toward the secondary closed position;

FIG. 14 is a view similar to FIG. 13 showing the striker continuing along the direction of arrow A and the ratchet being moved to the secondary closed position;

FIG. 15 is a view similar to FIG. 14 showing the striker continuing along the direction of arrow A and the ratchet being moved toward the primary closed position; and

FIG. 16 is a view similar to FIG. 15 showing the striker and the ratchet being moved to the primary closed position.

### DETAILED DESCRIPTION OF EXAMPLE EMBODIMENTS

In general, example embodiments of a double pull hood latch assembly constructed in accordance with the teachings of the present disclosure and vehicle therewith will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily appreciated and understood by a person possessing ordinary skill in the art in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

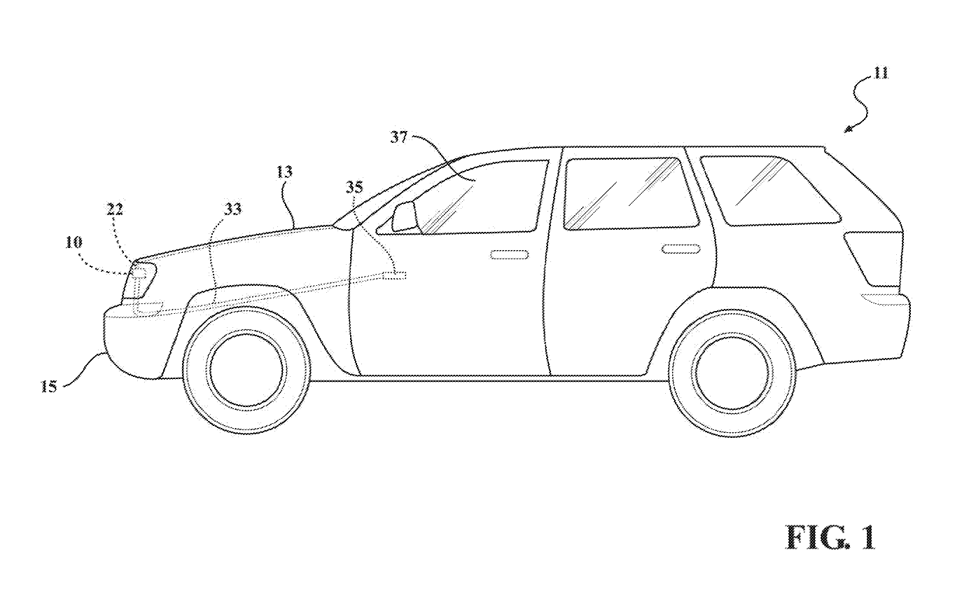

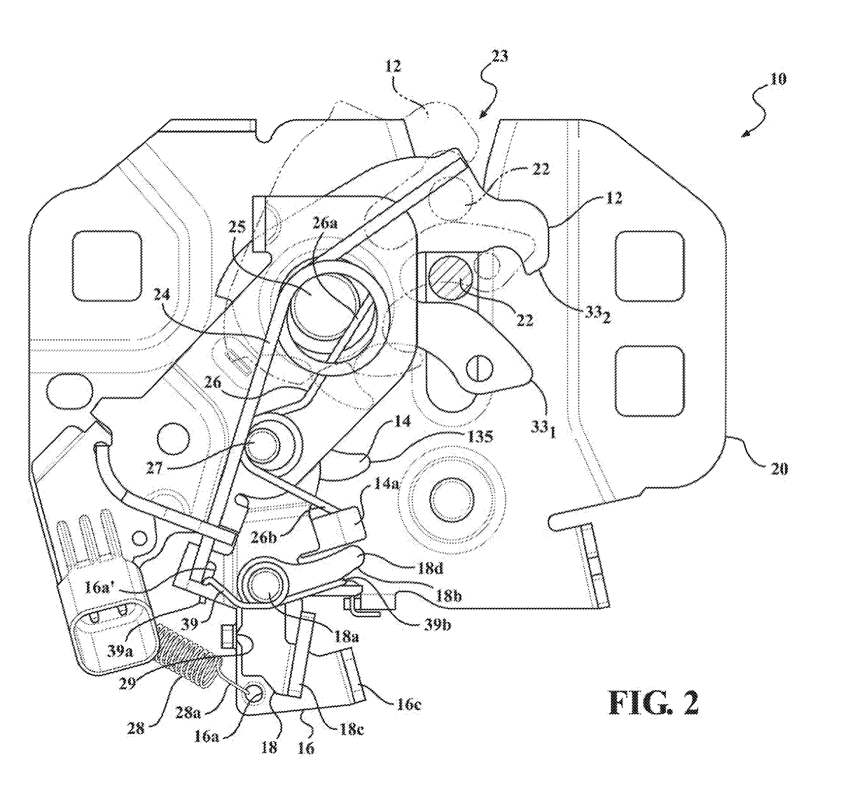

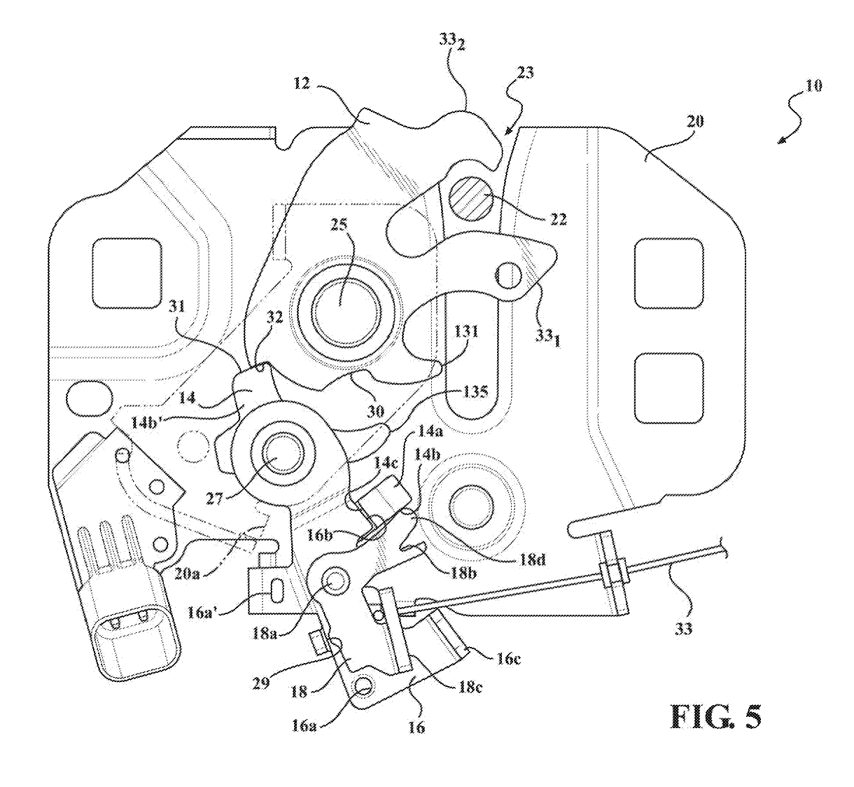

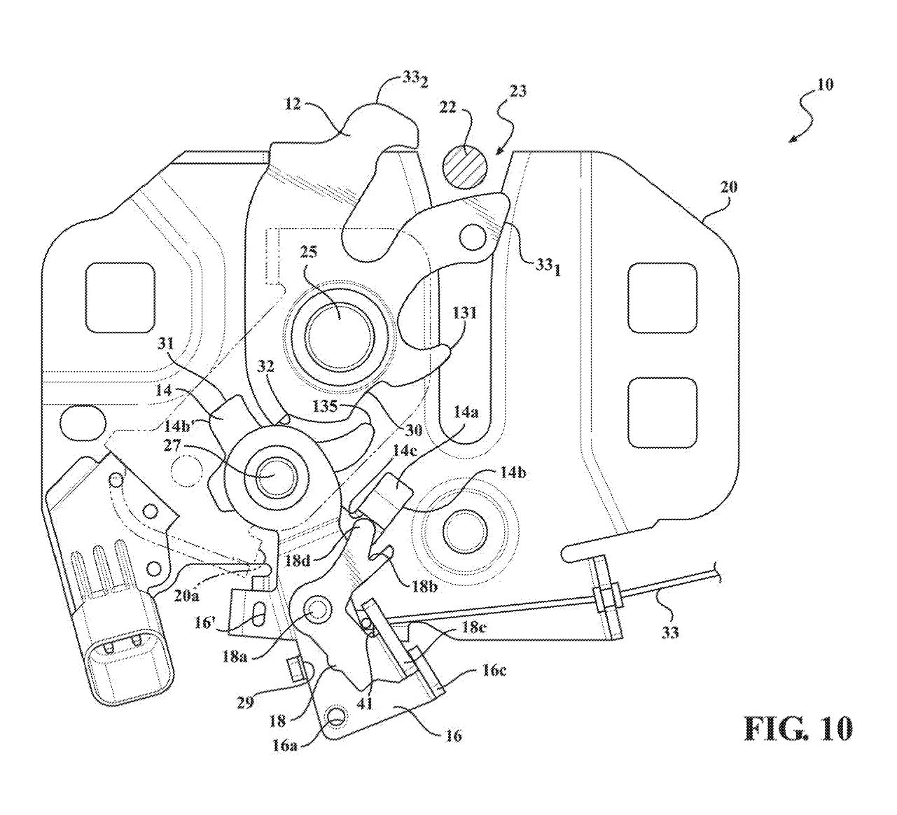

Reference is made to FIG. 1, which shows a vehicle 11 that has a closure panel, such as a hood, shown as a front engine compartment or frunk hood 13, by way of example and without limitation, to which there is a striker 22 attached. The striker 22 is capturable by a closure panel double pull latch assembly, which can also be referred to as a double pull hood latch assembly if used in a vehicle hood application, and is generally referred to hereafter simply as latch 10, which is mounted on a body 15 of the vehicle 11. Referring to FIG. 2, the latch 10 includes a ratchet 12, a pawl 14, a release lever 16, a double pull lever 18 (also referred to as extension member), and a housing 20. The ratchet 12 is pivotably connected to the housing 20 and is movable between a primary closed position (shown in solid in FIGS. 2, 3, 16), a secondary closed position (shown in phantom in FIG. 2 and in solid in FIGS. 5-8, 14) and an open position (FIGS. 10-12). The pivotal movement of the ratchet 12 may take place about a pin 25 that can be mounted to the housing 20. In the primary and secondary closed positions, the ratchet 12 prevents the withdrawal of the striker 22 that is mounted to the vehicle hood 13 and/or some other closure panel having latch 10. When in the primary closed position, the ratchet 12 holds the striker 22 relatively deeper within a slot, commonly referred to fishmouth 23, of the housing 20, wherein the hood 13 is in a fully closed state, as compared to when ratchet 12 is in the secondary closed position, wherein the hood 13 is in a partially closed state. Thus, in the primary closed position the ratchet 12 holds the striker 22 at a first depth in the fishmouth 23, and in the secondary closed position the ratchet 12 holds the striker 22 at a second depth in the fishmouth 23 of the housing 20, wherein the first depth is greater than the second depth.

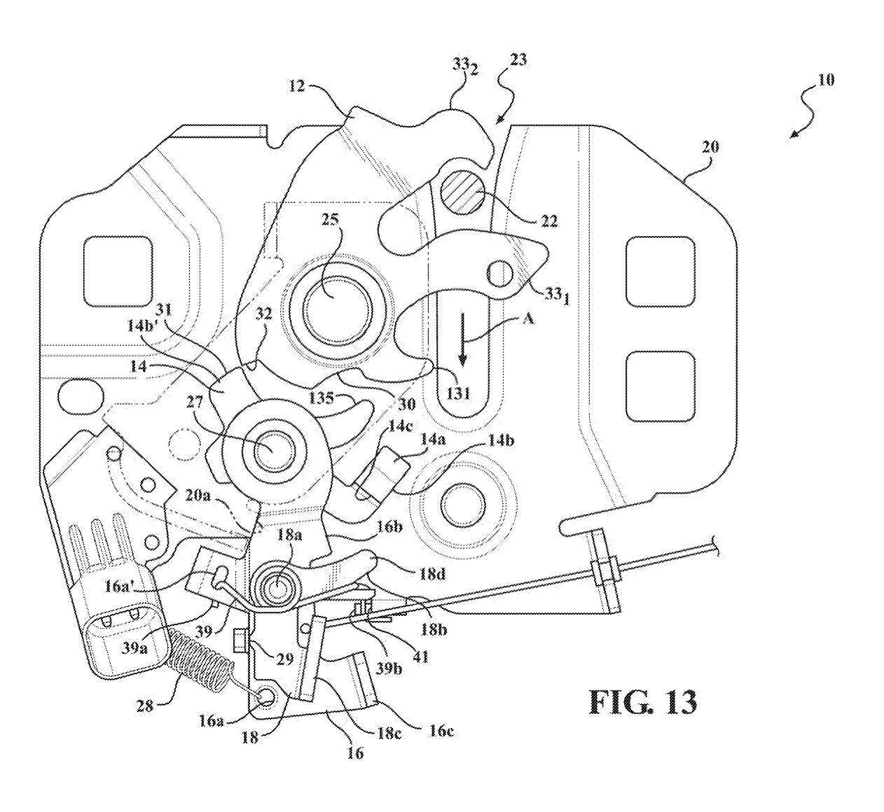

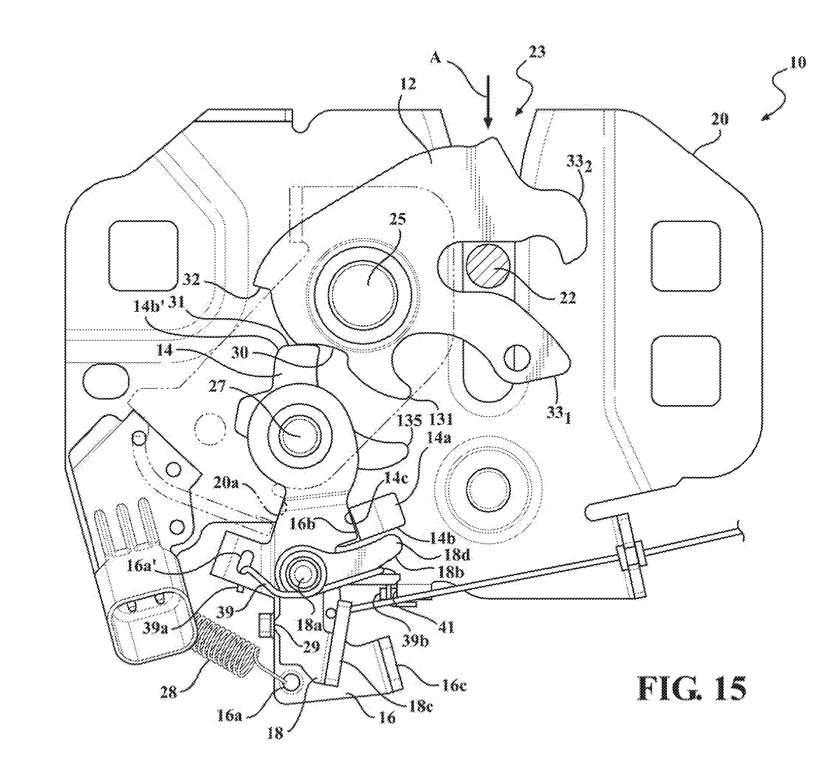

The ratchet 12 is biased toward the open position by a ratchet biasing member 24 (FIG. 2), as is common and known. The ratchet biasing member 24 may be, for example, a spring member, such as a torsion spring, by way of example and without limitation. The ratchet 12 further includes a projecting arm 131 positioned between pawl locking surface 31 and a first arm 33₁ forming part of the fishmouth 23 along with second arm 332. Ratchet projecting arm 131 is illustratively shown as a curved hook member extending in a counterclockwise direction from the ratchet 14. Pawl 14 also illustratively includes a pawl projecting arm 135 similarly extending from the pawl 14 in a curved manner. Pawl projecting arm 135 is illustratively shown as projecting from the pawl 14 at a position between the upstanding abutment tab 14a and a pawl tab 14b′ engageable with the pawl locking surface 31. During closing event, that is when the ratchet 12 is urged from the open position towards the primary closed position due to engagement by the striker 22 with the first arm 33₁, for example during a slamming or normal closing of the closure panel 13, as illustrated in FIGS. 13-16, ratchet projecting arm 131 may be brought into engagement with pawl projecting arm 135 when pawl projecting arm 135 is positioned in an interference trajectory with ratchet projecting arm 131 to impart upon contact between arms 131, 135 a rotation of the pawl 14 clockwise and towards the secondary, or primary, locking position, to provide a supplemental force assist configuration to supplement the bias provided by pawl biasing member 26 (can be visualized in FIG. 13 by envisioning pawl 14 not rotating clockwise quickly enough under the bias of pawl biasing member 26). As an illustrative example, in a scenario whereby the pawl biasing member 26 is not able to bias the pawl 14 towards the secondary, or primary, locking position, upon continued rotation of the ratchet 24 when the ratchet 12 is urged from the open position towards the primary closed position due to engagement by the striker 22, the rotation of the ratchet projecting arm 131 will engage the pawl projecting arm 135 positioned in the path of the ratchet projecting arm 31 due to the pawl biasing member 26 unable to impart movement of the pawl 14 towards the secondary, or primary, locking position. Additionally, in the event of a slam of the closure panel 12, engagement of the ratchet projecting arm 131 with the pawl projecting arm 135 positioned in the path of the ratchet projecting arm 31 due to the pawl biasing member 26 unable to impart a sufficiently rapid movement of the pawl 14 towards the secondary, or primary, locking position in comparison to the rapid rotation of the ratchet 12 towards the closed position as a result of the slam will allow the pawl 14 to engage the ratchet 12 in at least the secondary locking position.

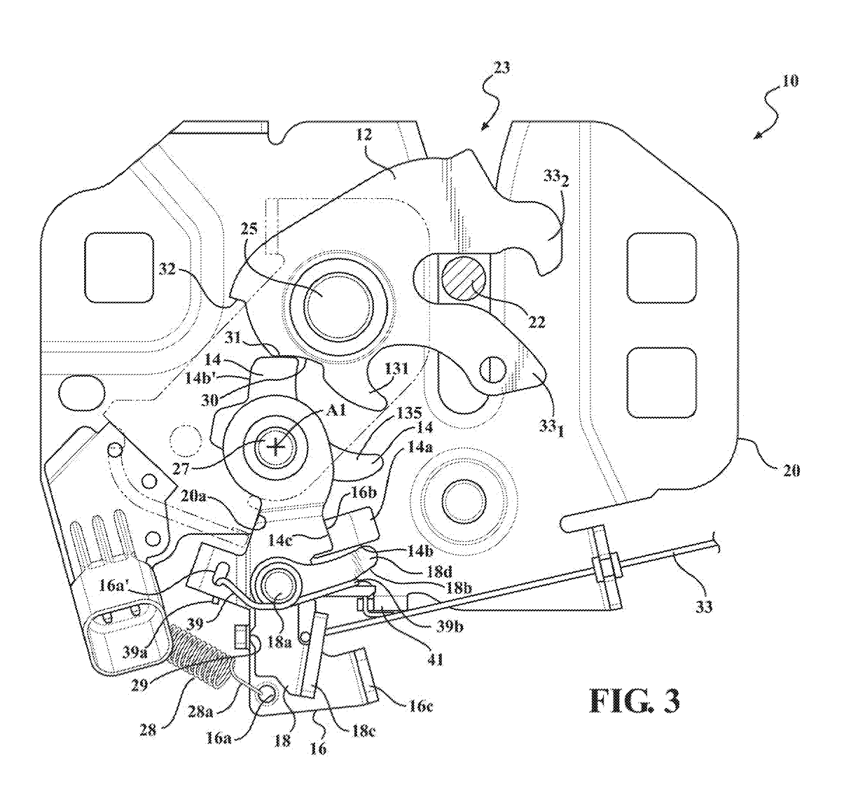

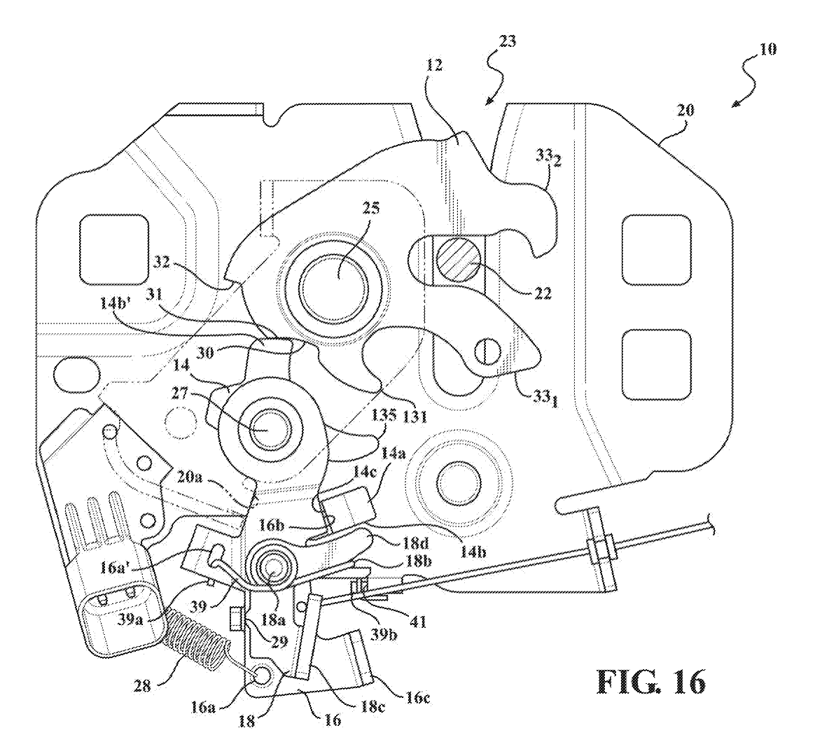

Pawl 14 is pivotably connected to housing 20 and is movable between a primary locking position (FIGS. 3, 16), a secondary locking position (FIGS. 5-8, 14) and an unlocking position (FIGS. 10-12). The pivotal movement of the pawl 14 may be about a pin 27, which defines an axis A1 (FIG. 3), also referred to as a pawl pivot axis or simply as pawl axis. While in the primary locking position (FIGS. 3, 16), a pawl locking surface 31 on pawl 14 engages a primary ratchet locking surface 30 on ratchet 12 and maintains the ratchet 12 in the primary closed position. In the secondary locking position (FIGS. 5-8, 14), the pawl locking surface 31 engages a secondary ratchet locking surface 32 on the ratchet 12 to hold the ratchet 12 in the secondary closed position. In the unlocking position (FIGS. 10-12) the pawl 14 permits the ratchet 12 to move to the open position under the bias of ratchet biasing member 24. The pawl 14 is biased toward the primary locking position by a pawl biasing member 26 (FIG. 2). The pawl biasing member 26 may be, for example, a spring member, such as a torsion spring, by way of example and without limitation. The torsion spring 26 may extend around the pin 27 and have a first end 26a abutting pin 25 and a second end 26b that engages a side of an upstanding abutment tab 14a formed as part of pawl 14. The abutment tab 14a extends laterally outwardly from a general plane of pawl 14 so as to be selectively engageable by the release lever 16 and the double pull lever 18, as explained in further detail below.

The release lever 16 can be pivotably connected to the housing 20 and is movable between a rest position, also referred to as home position (FIGS. 3, 6, 7), and a fully actuated position (FIGS. 5, 10). The pivotal movement of the release lever 16 may be about the same pin 27 and axis A1 (FIG. 3) about which the pawl 14 pivots. Thus the axis A1 may be referred to as a release lever axis in addition to pawl axis. Actuation of the release lever 16 (i.e. movement of the release lever 16 from the home position to the actuated position), in direct response to actuated movement of the double pull lever 18 via selective actuation of a release member 33 in a first pull, as discussed further below, drives pivotal movement of the pawl 14 from the primary locking position to the secondary locking position via direct driving engagement of the release lever 16 with the pawl 14. Further yet, actuation of the release lever 16 (i.e. movement of the release lever 16 from the home position to the actuated position), in response to movement of the double pull lever 18 in a second pull, as discussed further below, drives movement of the pawl 14 from the secondary locking position to the unlocked position via direct engagement of the double pull lever 18 with the pawl 14. Accordingly, the release lever 16 is free from attachment to a rod or cable, wherein movement of the release lever 16 to the actuated position is caused via direct engagement with the double pull lever 18. The release lever 16 is biased toward the home position by a release lever biasing member 28. The release lever biasing member 28 may be, for example a spring member, such as a coil spring, by way of example and without limitation. The coil spring 28 may have a first end (hidden, and thus, not shown) anchored through an aperture in the housing 20, and a second end 28a that extends through an aperture 16a in the release lever 16.

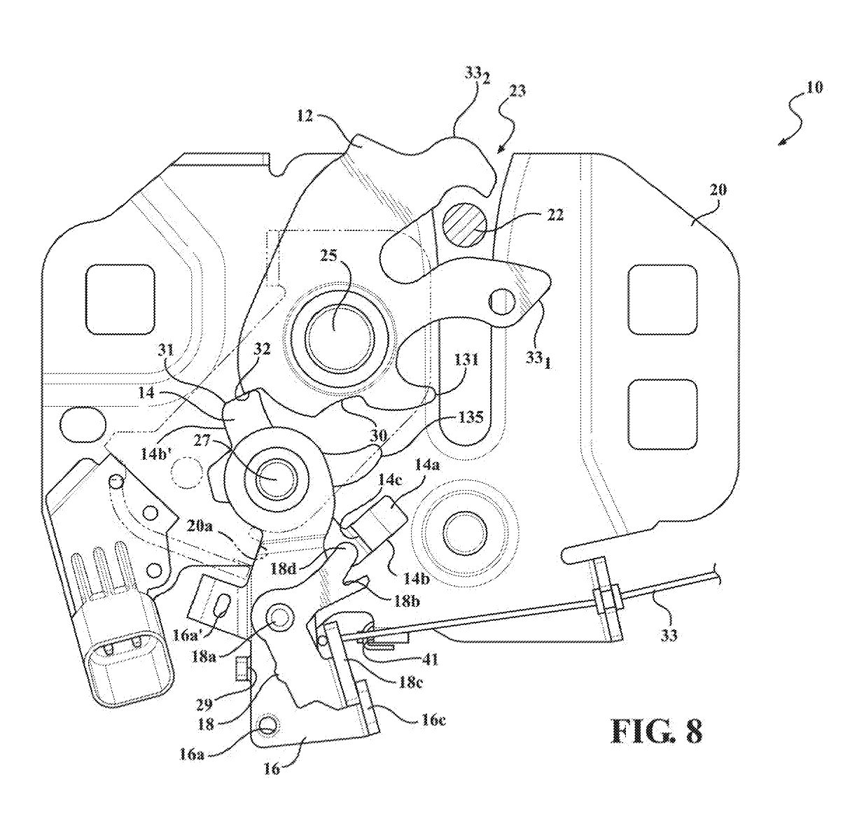

The double pull lever 18 is pivotably connected to the release lever 16 via pin 18a and is pivotably movable on and relative to the release lever 16 between an inoperative position (FIGS. 3-5), and an operative position (FIGS. 8-10). While in the inoperative position, such as when the pawl 14 is between the primary locking position and the secondary locking position, the double pull lever 18 does not directly effectively extend the driving reach capable of acting on pawl 14, and thus, while in the inoperative position, the double pull lever 18 does not directly drive movement of the pawl 14 when the release lever 16 is indirectly actuated (actuating force is not directly applied to release lever 16, but rather, actuating force is indirectly applied to release lever 16 via double pull lever 18, as discussed further below) via direct actuation of the double pull lever 18 (actuating force is directly applied to double pull lever 18 via release member 33, as discussed further below). However, while in the operative position, such as during a second actuation while the pawl 14 is in the secondary locking position, the double pull lever 18 does effectively extend the driving reach capable of acting on pawl 14, and does directly drive movement of the pawl 14 when the release lever 16 is indirectly actuated via direct actuation of the double pull lever 18 via release member 33, as described further below. The double pull lever 18 is biased toward the inoperative position by a double pull lever biasing member 39 (FIGS. 2, 3, 13-16). The double pull lever biasing member 39 may be, for example, a spring member, such as a torsion spring, by way of example and without limitation. The torsion spring 39 may extend around the pin 18a and have a first end 39a anchored in an opening 16a′ in the release lever 16, and a second end 39b that extends through a notch, shown as a forked or bifurcated notch 18b extending into an outer periphery of the double pull lever 18. The release member assembly, such as including a release rod or release cable 33, by way of example and without limitation, directly connects the double pull lever 18 to an actuation member of the release member assembly, such as an actuation handle 35 (FIG. 1) in the passenger compartment 37 of the vehicle, by way of example and without limitation. Actuation of the handle 35, such as via pulling the handle 35, imparts a pulling force directly on the double pull lever 18, which in turn imparts a driving force on release lever 16 through the connection to and abutment with double pull lever 18 and causes the release lever 16 to move from the home position to the actuated position.

When the latch 10 is positioned in the primary closed position, as shown in FIG. 3, the double pull lever 18 is prevented from leaving the inoperative position due to engagement of double pull lever 18 with the abutment tab 14a on the pawl 14. When the pawl 14 is in the primary locking position, the abutment tab 14a on the pawl 14 prevents the double pull lever 18 from rotating relative to release lever 16 into the operative position, wherein the operative position is a position between and bridging the pawl 14 with the release lever 16. As such, when the pawl 14 is in the primary locking position, direct actuated movement of the double pull lever 18 causes the double pull lever 18 to remain in the inoperative position and the release lever 16 to pivot into direct abutment with the pawl 14 to move pawl 14 from the primary locking position to the secondary locking position, as discussed further below. Additionally, in a non-limiting embodiment, an upstanding surface 20a (extending laterally outwardly from a main plane of housing 20) on the housing 20 may be used to limit the return travel of the release lever 16 to the home position under the urging of the release lever biasing member 28.

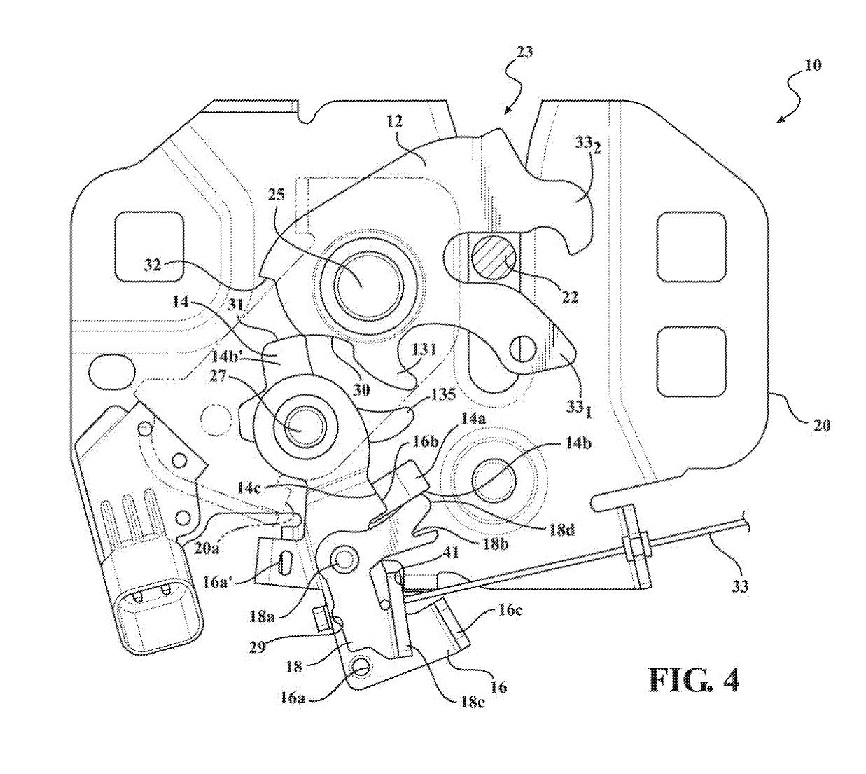

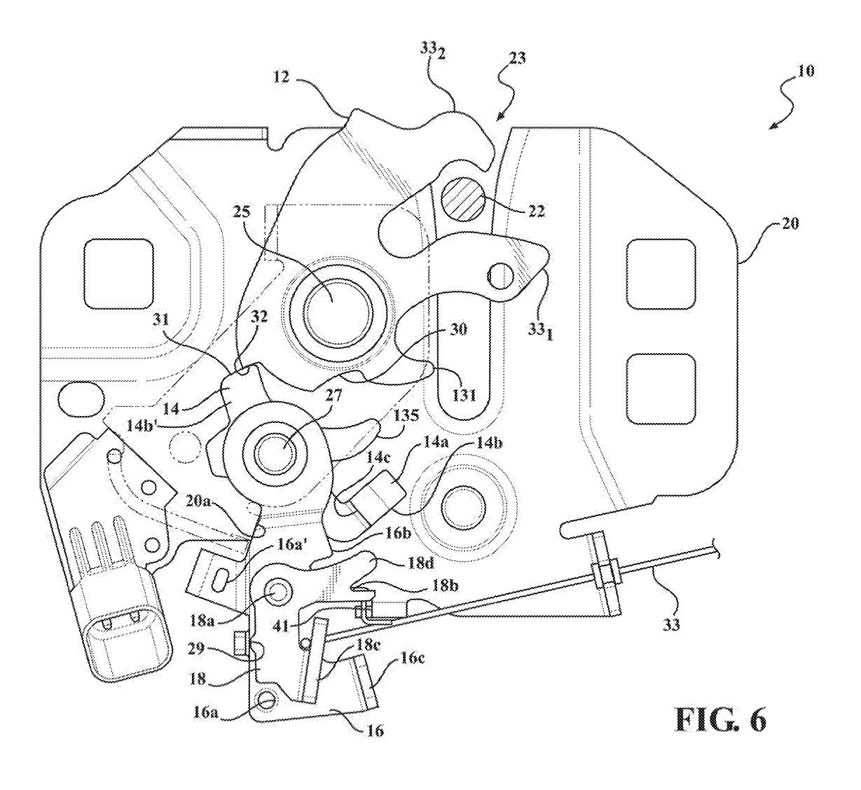

The operation of the latch 10 is generally as follows. The latch 10 is shown in the primary closed position in FIG. 3. In this position, the pawl 14 engages the primary locking surface 30 on the ratchet 12 and holds the ratchet 12 in the primary closed position, which is the position the latch 10 remains in as long as the vehicle closure panel (e.g. hood 13) remains in a fully closed position. Then, when desired, the latch 10 can be selectively actuated, to selectively move the ratchet 12 from the primary closed position to the secondary closed position, and then, from the secondary closed position to the open position, via a vehicle occupant inside a passenger compartment 37 (FIG. 1) of the vehicle 11, by way of example and without limitation. The vehicle occupant can perform a first actuation (e.g. pull or otherwise) of the handle 35, which has the effect of actuating the release cable 33, such as by pulling the release cable 33, and in turn, actuates the double pull lever 18, such as by pulling directly on a tab, referred to hereafter as an actuation/stop tab 18c, of the double pull lever 18 via direct connection of the release cable 33 to the actuation/stop tab 18c. With an integral monolithic extension 18d of the double pull lever 18 being in abutment with a blocking side surface 14b of the abutment tab 14a of the pawl 14, the double pull lever 18 is initially obstructed and prevented from rotating relative to the release lever 16 into operative bridging relation between the release lever 16 and pawl 14. As such, with the extension 18d abutting the side surface 14b, the pulling force of release cable 33 on actuation/stop tab 18c causes the double pull lever 18 and the release lever 16 to be driven conjointly in mutually fixed relation with one another in a counterclockwise direction (as viewed in FIG. 3) pivotably about common axis A1 to bring the release lever 16 to the fully actuated position, as shown in FIG. 5 (FIG. 4 shows the release lever 16 just prior to being moved to the fully actuated position). In the position shown in FIG. 3, the double pull lever 18 is in the inoperative position, in which it remains as long as the extension 18d confronts the side surface 14b of the abutment tab 14a, and thus, the double pull lever 18 is unable to directly rotate the pawl 14; however, an outer peripheral actuation surface 16b of the release lever 16, being in abutment with a front drive surface 14c of pawl 14, applies a force on the front drive surface 14c of pawl 14 in a direction that causes the pawl 14 to be driven about axis A1, thereby pivoting the pawl 14 from the primary locking position (FIG. 3) to the secondary locking position (FIG. 5). Accordingly, direct actuation of the double pull release lever 18 via cable 33 while in the inoperative position causes pivoting actuation of the release lever 16, thereby driving the pawl 14 to the secondary locking position, whereat the ratchet 12 is then caused to move from the primary closed position to the secondary closed position, as shown in FIG. 6, under the bias of the ratchet biasing member 24.

As can be seen in FIGS. 4 and 5, the fully actuated position for the release lever 16 can be predetermined by a release lever limit surface 41 extending upwardly from a general plane of the housing 20, wherein the release lever limit surface 41 can be formed as a part of the housing 20, such as via a bent tab portion, or otherwise. Accordingly, the release lever limit surface 41 determines the fully actuated position of the release lever 16 and prevents movement of the release lever 16 thereby. Accordingly, the release lever 16 is prevented from being able to directly drive the pawl 14 past the secondary locking position over the course of the first pull actuation of the handle 35, thereby preventing the ratchet 12 from moving to the fully open position.

After actuating the release lever 16 via directly actuating the double pull lever 18 over the course of the first pull, the vehicle occupant may release the handle 35 permitting the double pull lever 18 and release lever 16 to return to the home position, as shown in FIG. 6, under the bias of respective double pull lever and release lever biasing members 39, 28. The position shown in FIG. 6 corresponds to the secondary closed position of the latch 10. In this position, the ratchet 12 is held in the secondary closed position by engagement of the pawl 14 with the secondary ratchet locking surface 32 on the ratchet 12. As discussed above, during the movement of the pawl 14 from the primary locking position to the secondary locking position, the double pull lever 18 is prevented from moving to the operative position because such movement is obstructed by the side surface 14b of the abutment tab 14a on the pawl 14. Note, that the primary locking surface 30 is located at a radial distance relative to pin 25 that is smaller than the radial distance of the secondary ratchet locking surface 32 to pin 25 so that the secondary ratchet locking surface 32 can engage the pawl 14 upon rotation of the ratchet 12 without the pawl 14 having to return to an angular position similar to its primary locking position. As a result, the pawl 14 may be held in its secondary locking position which can allow the extension 18d to be moved (i.e. extension 18d no longer can confront the side surface 14b of the abutment tab 14a) into a position where abutment of the drive surface 14c of the pawl 14 with 14 is possible.

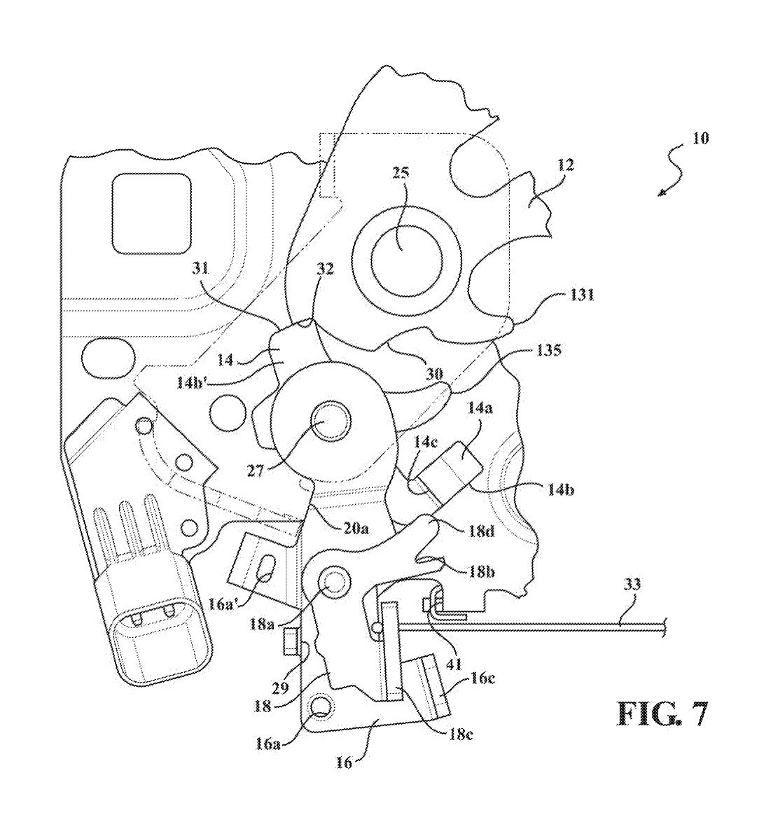

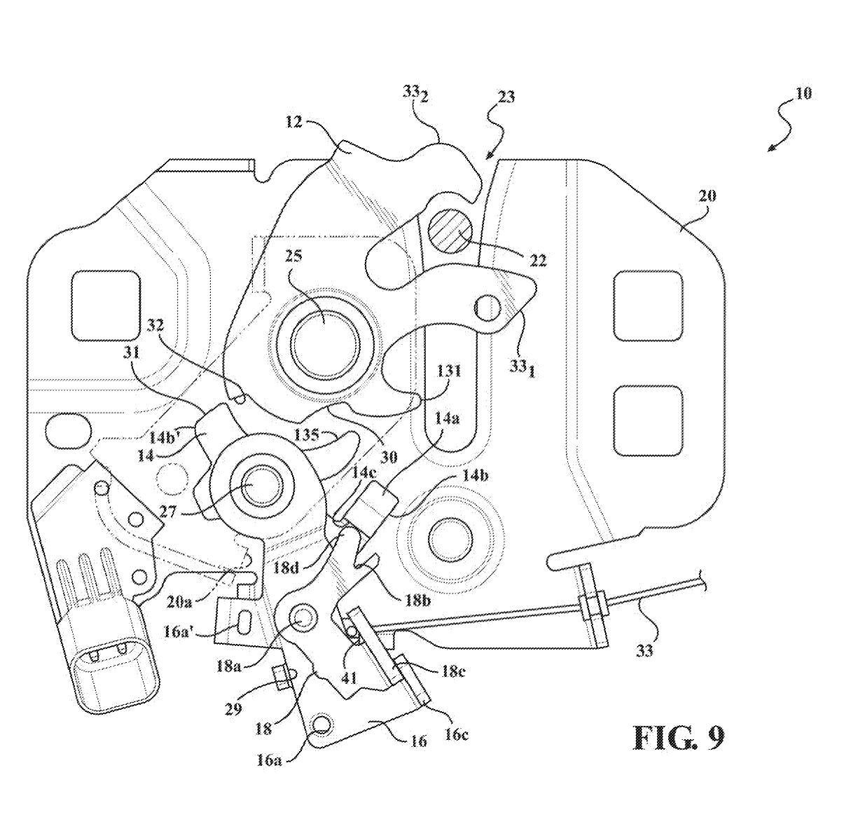

Then, to bring the latch 10 to the fully open position so as to fully release the striker 22 from the ratchet 12 of latch 10 and to allow the vehicle hood 13 to be opened, the vehicle occupant may again actuate the release lever 16 via performing a second pull of the handle 35 and cable 33. During the second pull, as shown in FIGS. 7 and 8, the double pull lever 18 is again acted on directly by release cable 33; however, unlike during the first pull event, the double pull lever 18 is caused to pivot relative to the release lever 17, which is made possible as a result of the side surface 14b of the pawl abutment tab 14a no longer obstructing and interfering with the pivotal movement of the double pull lever extension 18d. It will be recognized that the pull force imparted by the release cable 33 on the double pull lever 18 is sufficient to overcome the force of the double pull lever biasing member 39, but not the force of the release lever biasing member 28, and thus, it is to be recognized that the force imparted by the release lever biasing member 28 is greater than the force imparted by the double pull lever biasing member 39. Accordingly, the double pull lever 18 is caused to pivotably move about pin 18a under the direct pulling force of release cable 33 (counterclockwise in the view shown in FIGS. 6 and 7) to the operative position (FIG. 8) against the bias of the biasing member 39. To ensure the double pull lever 18 does not over-travel or otherwise move beyond the desired operative position, the stop tab 18c confronts a positive stop 16c on the release lever 16, wherein the positive stop 16c can be formed as a monolithic piece of material with the release lever 16, such as via a bent tab, by way of example and without limitation. Once moved into the operative position via pivotal movement during the second pull, and with the stop tab 18c abutting the positive stop 16c, continued actuation movement of the double pull lever 18 under the applied force from the release cable 33 causes the release lever 16 to pivot about pivot axis A1 of pin 27, wherein the double pull lever 18 is caused to move conjointly with release lever 16 such that double pull lever 18 is caused to rotate (orbit) about pivot axis A1. The rotational movement of the double pull lever 18 relative to release lever 16 about pivot axis A1 causes the double pull lever extension 18d to move into bridged, abutting relation between release lever 16 and pawl 14, shown as extending from pin 18a to drive surface 14c to directly engage the drive surface 14c of the pawl 14, which causes the pawl 14 to be pivoted further in a counterclockwise direction about pin 27 to move from the secondary locking position (FIGS. 5-8) to the unlocking position (FIGS. 10-12). FIG. 9 shows the pawl 14 pivotably moved to a position between the secondary locking position and the unlocked position. Movement of the pawl 14 to the unlocking position then permits automatic movement of the ratchet 12 to the open position shown in FIG. 9 under the bias of the ratchet biasing member 24 (FIG. 2), thereby permitting the striker 22 to leave the ratchet 12 and the hood 13 (FIG. 1) to open.

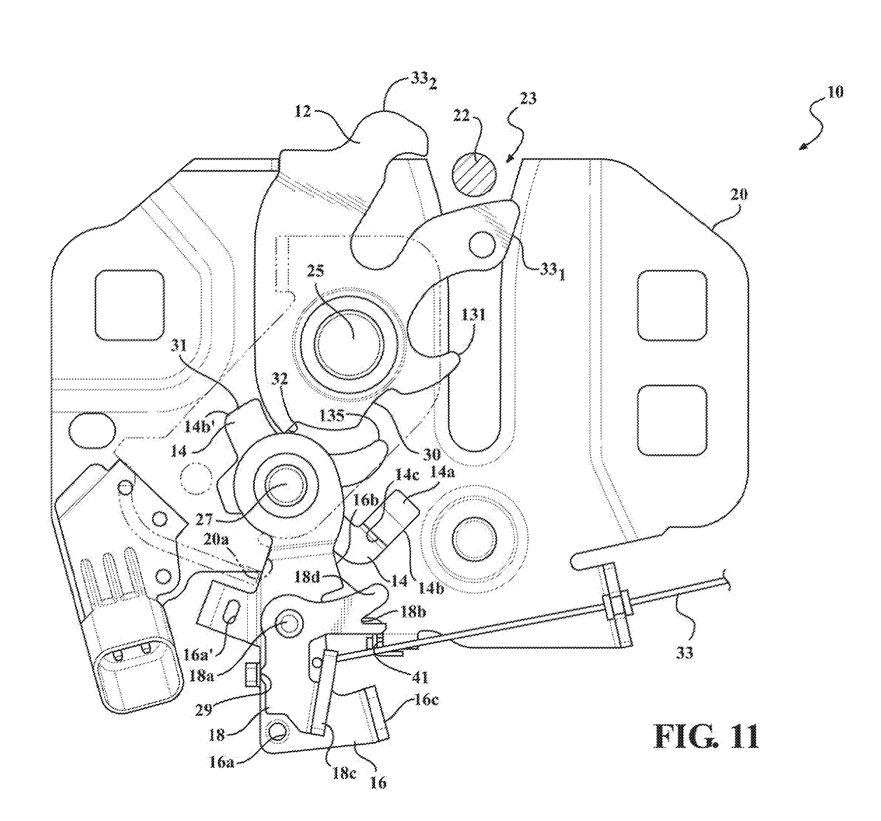

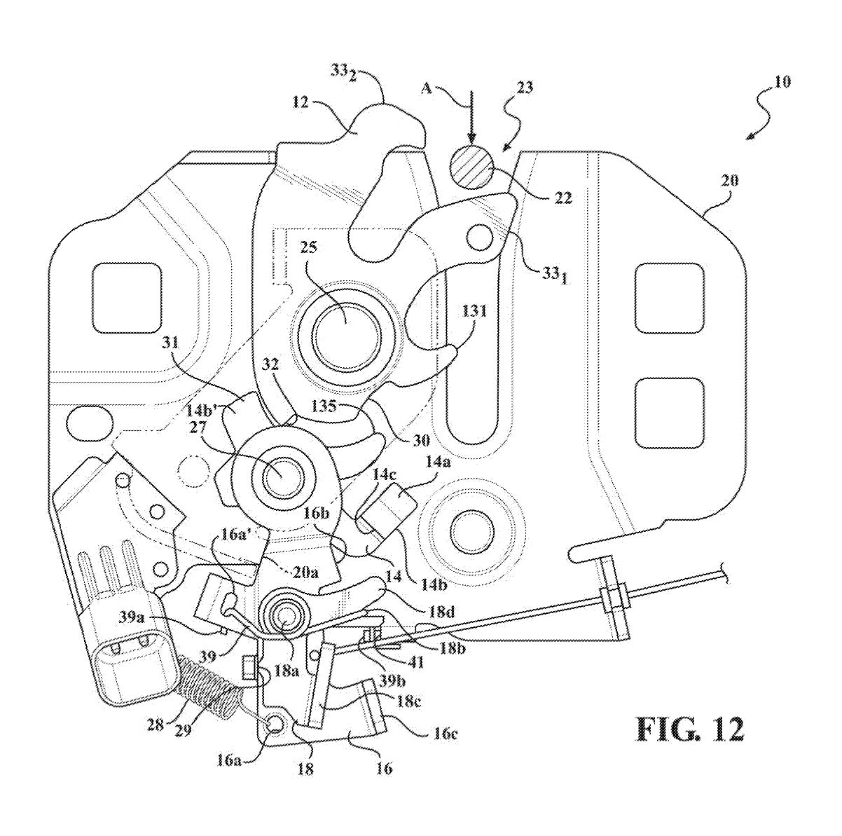

Upon completing the second pull, the handle 35 is released to remove the pulling force from the release cable 33, and as a result, the double pull lever 18 and release lever 16 are able to automatically return to the home position as shown in FIGS. 11 and 12 under the bias of respective double pull lever and release lever biasing members 39, 28, similarly as discussed above subsequent to the first pull. As shown in FIGS. 11 and 12, the movement of the double pull lever 18 and release lever 16 back to the home position brings the double pull lever 18 back into engagement with an upstanding home stop surface 29 on the release lever 16 under the bias of the double pull lever biasing member 39, which automatically returns the double pull lever 18 to the inoperative position for subsequent action, as discussed above, upon returning the ratchet 12 of latch 10 to the secondary and primary closed positions.

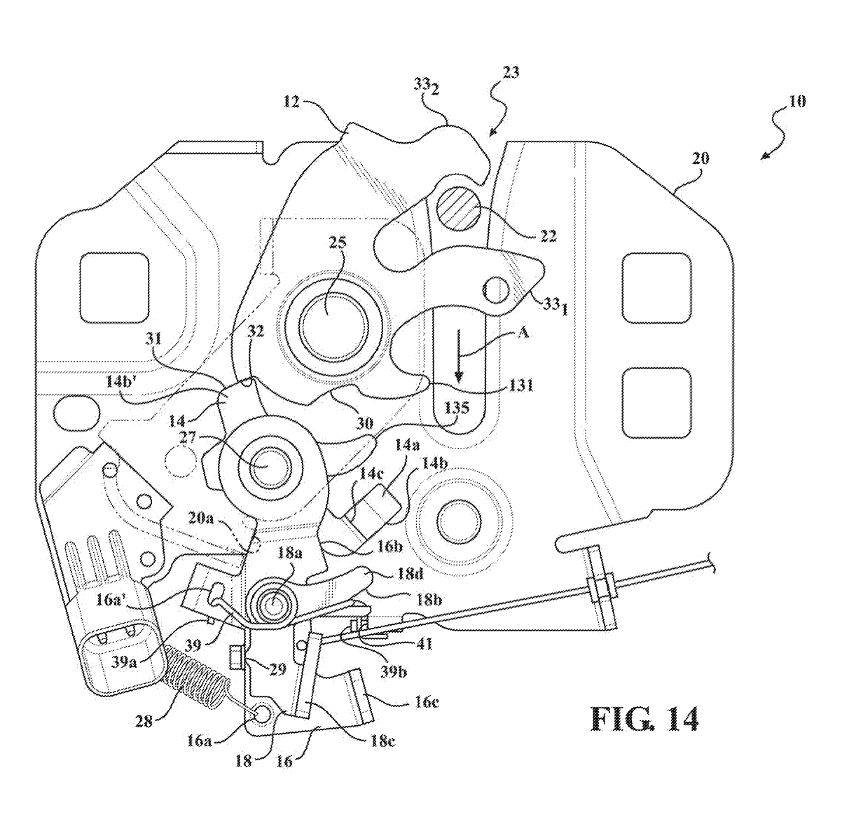

In the latch position shown in FIG. 12, latch 10 is set to be closed upon entry of the striker 22 into the fishmouth 23. When such entry of the striker 22 into the fishmouth 23 occurs (e.g. when a pedestrian, vehicle occupant or driver closes the hood 13 (FIG. 1), the striker 22 moves along direction or arrow A and drives the ratchet 12 back to the secondary closed position shown in FIG. 14, and if the striker 22 continues along direction A, the ratchet 12 is ultimately moved to the primary closed position shown in FIG. 16. During such movement of the ratchet 12, the pawl 14 can move under the bias of the pawl biasing member 26 (FIG. 2) from the unlocking position shown in FIG. 12 to the secondary locking position shown in FIG. 14, where it can remain if desired, and then finally to the primary locking position shown in FIG. 16 under continued movement of striker 22 along the direction of arrow A to the fully closed position (FIG. 16). Because the double pull lever 18 is maintained in the inoperative position via the double pull lever biasing member 39 against the home stop surface 29, the double pull lever 18 permits the free return of the pawl 14 without obstruction to the primary locking position shown in FIG. 16.

It will be noted that, when the latch 10 is in the secondary closed position (FIG. 6), the vehicle occupant can decide that they do not want to fully open the hood 13 and can press down on the hood 13 to return the ratchet 12 to the primary closed position, thereby returning the hood 13 to the fully closed position. In such an event, the movement of the pawl 14 from the secondary locking position to the primary locking position is permitted by the double pull lever 18 because the double pull lever 18 is maintained in the inoperative position against the positive stop surface 29 via double pull biasing member 39.

It has been disclosed for the pawl 14 to prevent the double pull lever 18 from moving to the operative position during movement of the pawl 14 from the primary locking position to the secondary locking position (and during movement of the ratchet 12 from the primary closed position to the secondary closed position). It is alternatively possible for the ratchet 12 itself to prevent the double pull lever 18 from moving to the operative position during movement of the pawl 14 during movement of the ratchet 12 from the primary closed position to the secondary closed position. For example, the ratchet 12 could be provided with an arm that is engageable with double pull lever 18 to obstruct the movement of the double pull lever 18 to the operative position. The arm would engage and obstruct the double pull lever 18 during travel of the ratchet 12 to the secondary closed position, at which point the arm would leave and move out from obstructive engagement from the double pull lever 18 to permit the double pull lever 18 to pivot into engagement with the drive surface 14c on the pawl 14 under the urging of the force applied by the cable 33.

Use of the latch 10 eliminates the need for the occupant to pull a lever or handle inside the vehicle and then exit the vehicle to go to the hood 13 or other closure panel, and release the hood 13 or other closure panel by manually finding and actuating a second lever with their hands, which can dirty the occupant's hands and which can be otherwise inconvenient.

Furthermore, latch 10 avoids a situation where an occupant inadvertently completely opens the hood 13 after actuating the handle 35 only a single time.

Further yet, latch 10 is able to be actuated with an increased level of confidence that the ratchet 12 is going to be moved from the primary closed position, and then to the open position, as desired, without concern of the release lever 16 and double pull lever 18 being inhibited from movement, as intended. The enhanced and reliable performance is provided, at least in part, as a result of the release cable 33 acting directly on the double pull lever 18, which in turn causes the double pull lever 18 to forcibly confront and abut the release lever 16 to drive the release lever 16 about pin 27 accordingly, and also to confront and abut the pawl 14 to drive the pawl 14 about pin 27 accordingly. As such, pivotal movement of the double pull lever 18 from the inoperative position to the operative position is not solely reliant on a force of a biasing spring member, but is provided via a relatively increased, (relative to that of a spring member), direct force applied by the pulling force of release cable 33 that is directly coupled thereto. As such, if release lever 16 and double pull lever 18 is unable to move under force of bias imparted by a biasing spring member, the force applied directly to the double pull lever 18 via the release cable 33 is generally capable of providing such bias force to cause movement of the release lever 16 and double pull lever 18. Accordingly, the vehicle occupant is able to reliably open the closure panel (e.g. hood 13) without concern of the latch 10 malfunctioning or otherwise being temporarily inoperable.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with the example detection system can likewise be implemented into many other systems to control one or more operations and/or functions.

What is claimed is:

1. A latch, comprising:
a ratchet movable between a primary closed position, a secondary closed position and an open position, wherein said ratchet being biased toward said open position;
a pawl movable between a primary locking position whereat a pawl locking surface of said pawl engages a primary locking surface of said ratchet to hold said ratchet in the primary closed position, a secondary locking position whereat said pawl locking surface engages a secondary locking surface of said ratchet to hold said ratchet in the secondary closed position, and an unlocking position, wherein said pawl is biased toward the primary locking position;
a release lever movable between a home position and an actuated position; and
a double pull lever configured for attachment to a release cable, said double pull lever being mounted to said release lever for movement between an inoperative position and an operative position, wherein when said double pull lever is in the inoperative position, movement of said release lever to said actuated position, in response to a force applied to said double pull lever by a first actuation of the release cable, causes said release lever to engage said pawl and drive said pawl from the primary locking position to the secondary locking position, and wherein when said double pull lever is in the operative position, movement of said release lever to said actuated position, in response to a force applied to said double pull lever by a second actuation of the release cable, causes said double pull lever to engage said pawl and drive said pawl from the secondary locking position to the unlocking position.

2. The latch of claim 1, wherein when said pawl is driven from the primary locking position to the secondary locking position by said release lever, said double pull lever is prevented from moving to said operative position, and when said pawl is in the secondary locking position, movement of said double pull lever to said operative position is permitted in response to a force applied to said double pull lever by the release cable.

3. The latch of claim 2, wherein said pawl obstructs said double pull lever from moving to the operative position when said pawl is between the primary locking position and the secondary locking position.

4. The latch of claim 2, wherein said pawl inhibits relative rotation between said double pull lever and said release lever when said pawl is moving from the primary locking position toward the secondary locking position.

5. The latch of claim 4, wherein said double pull lever rotatably abuts a tab of said pawl when said pawl is moving from the primary locking position toward the secondary locking position.

6. The latch of claim 4, wherein said double pull lever can rotate relative to said release lever when said pawl is in said secondary locking position and a force is applied to said double pull lever by the release cable.

7. The latch of claim 6, wherein said double pull lever rotates relative to said release lever from the inoperative position to the operative position when said pawl is in said secondary locking position and a force is applied to said double pull lever by the release cable.

8. The latch of claim 7, wherein said double pull lever rotates into abutment with a positive stop on said release lever when in the operative position.

9. The latch of claim 1, wherein said release lever directly abuts said pawl to drive said pawl from the primary locking position to the secondary locking position, and wherein said double pull lever directly abuts said pawl to drive said pawl from the secondary locking position to the unlocking position.

10. The latch of claim 1, wherein said release lever is biased toward the home position by a first bias member and wherein said double pull lever is biased toward said inoperative position by a second bias member, wherein said first bias member imparts a first bias force and said second bias member imparts a second bias force, said first bias force being greater than said second bias force.

11. A latch, comprising:
a housing;
a ratchet mounted to said housing, said ratchet being movable between a primary closed position, a secondary closed position and an open position, wherein said ratchet is biased toward said open position;
a pawl mounted to said housing, said pawl being movable between a primary locking position whereat a pawl locking surface of said pawl engages a primary locking surface of said ratchet to hold the ratchet in the primary closed position, a secondary locking position whereat said pawl locking surface engages a secondary locking surface of said ratchet to hold the ratchet in the secondary closed position, and an unlocking position, wherein said pawl is biased toward the primary locking position;
a release lever mounted to said housing, said release lever being movable between a home position and an actuated position, wherein said release lever is biased toward the home position by a first bias member; and
a double pull lever configured for direct attachment to a release cable assembly, said double pull lever being mounted to said release lever for movement between an inoperative position and an operative position, wherein when said double pull lever is in the inoperative position, movement of said release lever to said actuated position, in response to a force applied to said double pull lever by a first actuation of the release cable assembly, causes said release lever to engage said pawl and drive said pawl from the primary locking position to the secondary locking position, and wherein when said double pull lever is in the operative position while the pawl is in the secondary locking position, movement of said release lever to said actuated position, in response to a force applied to said double pull lever by a second actuation of the release cable assembly, causes said double pull lever to drive said pawl from the secondary locking position to the unlocking position.

12. The latch of claim 11, wherein while said pawl is between the primary locking position and the secondary locking position, said double pull lever is prevented from moving to said operative position, and while said pawl is in the secondary locking position, movement of said double pull lever to said operative position is permitted in response to a force applied to said double pull lever by the release cable assembly.

13. The latch of claim 12, wherein pawl inhibits relative rotation between said double pull lever and said release lever while said pawl is moving from the primary locking position toward the secondary locking position.

14. The latch of claim 13, wherein said double pull lever is rotatable relative to said release lever when a force is applied to said double pull lever by the release cable assembly while said pawl is in the secondary locking position.

15. The latch of claim 14, wherein said double pull lever rotates relative to said release lever into abutment with a positive stop on said release lever when a force is applied to said double pull lever by the release cable assembly while said pawl is in the secondary locking position.

16. The latch of claim 15, wherein said double pull lever and said pawl rotate conjointly about an axis during movement of said release lever to said actuated position upon the second actuation of the release cable assembly.

17. The latch of claim 16, wherein said release lever remains disengaged from said pawl during movement of said release lever to said actuated position upon the second actuation of the release cable assembly.

18. The latch of claim 17, wherein said double pull lever directly abuts said pawl during movement of said release lever to said actuated position upon the second actuation of the release cable assembly to drive said pawl from the secondary locking position to the unlocking position.

19. A latch, comprising:
a ratchet movable between a primary closed position, a secondary closed position and an open position, wherein said ratchet being biased toward said open position;
a pawl movable between a primary locking position whereat a pawl locking surface of said pawl engages a primary locking surface of said ratchet to hold said ratchet in the primary closed position, a secondary locking position whereat said pawl locking surface engages a secondary locking surface of said ratchet to hold said ratchet in the secondary closed position, and an unlocking position, wherein said pawl is biased toward the primary locking position;
a release lever movable between a home position and an actuated position; and
a double pull lever configured for direct attachment to a release cable, said double pull lever being mounted to said release lever for pivotal movement between an inoperative position and an operative position, wherein when said double pull lever is in the inoperative position, movement of said release lever to said actuated position, in response to a first actuation of the release cable, causes said release lever to directly engage said pawl and drive said pawl from the primary locking position to the secondary locking position, and wherein when said double pull lever is in the operative position, movement of said release lever to said actuated position, in response to a second actuation of the release cable, causes said double pull lever to directly engage said pawl and drive said pawl from the secondary locking position to the unlocking position.

20. The latch of claim 19, wherein said release lever is free from attachment to a rod or cable, wherein movement of said release lever to said actuated position is caused via engagement with said double pull lever.
